(19) United States
(12) Patent Application Publication
(10) Pub. No.: US 2025/0382137 A1
(43) Pub. Date: Dec. 18, 2025

(54) CONVEYING DEVICE AND CONVEYING METHOD

(71) Applicants: TOYOTA JIDOSHA KABUSHIKI KAISHA, Toyota-shi (JP); DAIRYU PRECISION MACHINE CO., LTD., Anan-shi (JP)

(72) Inventors: Yasuhiro AKITA, Toyota-shi (JP); Takuya OZAKI, Tokushima-shi (JP); Hirokazu TAGAMI, Anan-shi (JP); Manabu WAKAKI, Tokushima-shi (JP); Toshinori SHINOHARA, Anan-shi (JP)

(21) Appl. No.: 19/232,950

(22) Filed: Jun. 10, 2025

(30) Foreign Application Priority Data
Jun. 13, 2024 (JP) 2024-096011
Apr. 9, 2025 (JP) 2025-064268

(51) Int. Cl. B65G 33/06

(52) U.S. Cl. CPC B65G 33/06; B65G 2201/022; B65G 2812/0544

(57) ABSTRACT

A conveying device configured to align a plurality of fuel cells stacked on each other is provided, and the conveying device may include: a magazine accommodating the plurality of fuel cells in the stacked state along a first direction and having one end in the first direction being open; a first screw extending along the first direction and having an outer peripheral surface with a helical thread groove, in which the outer peripheral surface of the first screw contacts the plurality of fuel cells in a second direction perpendicular to the first direction when the plurality of fuel cells is accommodated in the magazine; and a screw driving unit configured to rotate the first screw.

### REFERENCE TO RELATED APPLICATIONS

This application claims priority from Japanese Patent Application No. 2024-96011 filed on Jun. 13, 2024 and Japanese Patent Application No. 2025-64268 filed on Apr. 9, 2025. The entire content of the priority applications is incorporated herein by reference.

### TECHNICAL FIELD

The art disclosed herein relates to an art for aligning a plurality of fuel cells.

### BACKGROUND ART

By stacking a plurality of fuel cells, a fuel cell stack as a structure is produced. Due to this, a process of producing a fuel cell stack includes a process of stacking a plurality of fuel cells. Conventionally, a pick-and-place method in which fuel cells are picked up one by one by using a robot hand and/or a suction pad, and a fuel cell is placed on a previously-placed fuel cell, such that the fuel cells are stacked upward, had been implemented.

In addition, Japanese Patent Application Publication No. 2010-212139 describes a configuration of stacking a plurality of cells in a lamination jig by using a conveying tray which includes: a slide guide that extends to two locations near a lower end of the cells and one location near a side edge of the cells and a gate plate that is arranged parallel to the cells, and is configured to open and close at one end of the slide guide.

### SUMMARY

From a perspective of improving quality of a fuel cell stack, it is demanded to align and stack a plurality of fuel cells with minimal misalignment between them. Furthermore, it is desired to achieve high-precision alignment with minimal misalignment at a higher speed.

In an aspect of the art disclosed herein, a conveying device configured to align a plurality of fuel cells stacked on each other is provided, and the conveying device may comprise: a magazine accommodating the plurality of fuel cells in the stacked state along a first direction and having one end in the first direction being open; a first screw extending along the first direction and having an outer peripheral surface with a helical thread groove, wherein the outer peripheral surface of the first screw contacts the plurality of fuel cells in a second direction perpendicular to the first direction when the plurality of fuel cells is accommodated in the magazine; and a screw driving unit configured to rotate the first screw.

According to the above configuration, by the screw driving unit rotating the first screw, each of the plurality of fuel cells stored in the magazine fits into the thread groove of the first screw and is conveyed in an aligned state along the first direction towards the one end. In addition, by adjusting a rotation speed of the first screw, a speed of the conveying can also be adjusted. Therefore, as compared to the conventional methods, the plurality of fuel cells can be aligned with high precision, and can be conveyed and stacked at a high speed.

### BRIEF DESCRIPTION OF DRAWINGS

FIG. 1 illustrates a configuration of a magazine from one end side along a first direction.

FIG. 2 illustrates the configuration of the magazine from other end side along the first direction.

FIG. 3 illustrates an exploded perspective view of the magazine.

FIG. 4 illustrates how a posture of a conveying device changes.

FIG. 5 illustrates how the conveying device conveys fuel cells.

FIG. 6 illustrates an enlarged view of a state where screws and the fuel cells are engaged with each other.

FIG. 7 illustrates how the conveying device conveys the fuel cells with the first direction inclined.

FIG. 8 illustrates a part of a screw.

FIG. 9 illustrates a plurality of examples of screws.

FIG. 10 illustrates a table showing test results for multiple test items for each of the examples of the screws.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved conveying devices, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

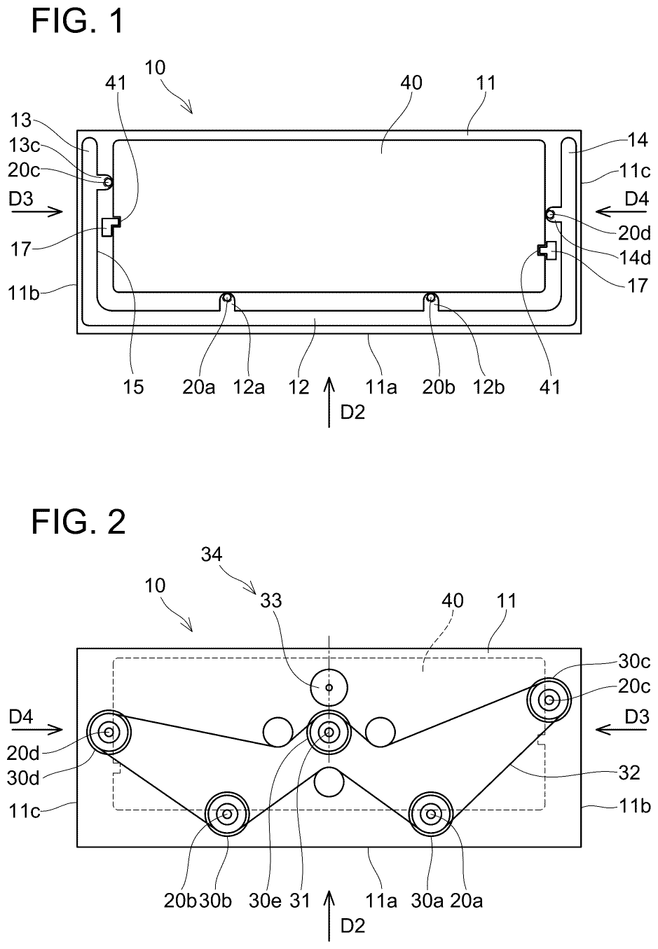

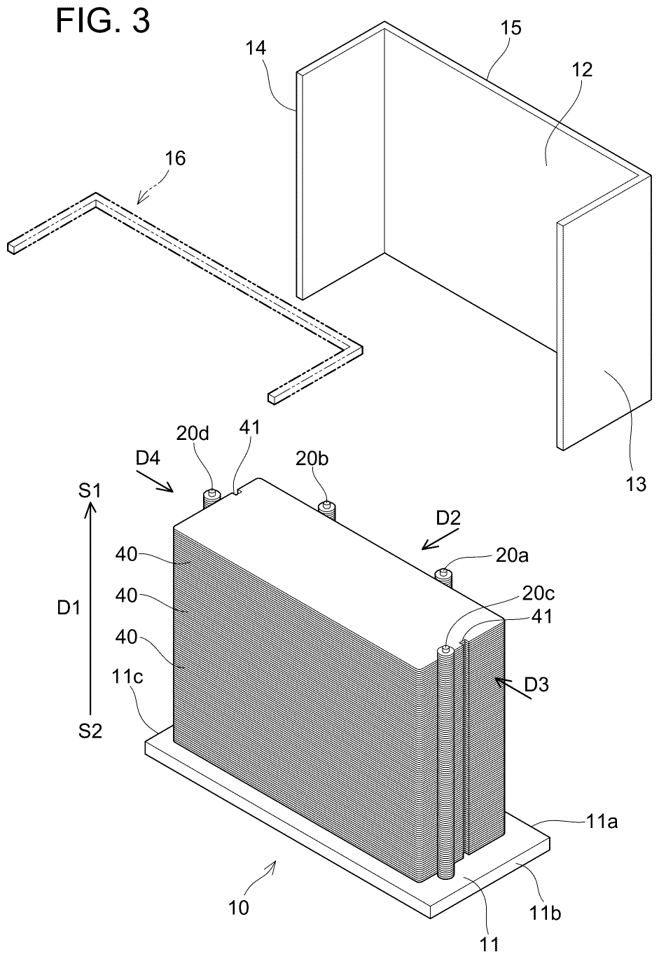

FIG. 1 schematically shows a configuration of a magazine 10 as seen from a one end side S1 along a first direction D1. FIG. 2 schematically shows the configuration of the magazine 10 as seem from other end side S2 along the first direction D1. FIG. 3 schematically shows the magazine 10 in an exploded perspective view. As illustrated in FIG. 3, the magazine 10 is a case, being a component configured to accommodate a plurality of fuel cells 40 in a stacked state of being stacked on each other along the first direction D1. Each fuel cell 40 is configured to be a plate having integrated layers, such as an electrolyte membrane, a pair of electrode plates sandwiching the electrolyte membrane, and a separator. Each fuel cell 40 is also referred to as a single cell. The magazine 10 has one end in the first direction D1 being open.

The magazine 10 comprises a support plate portion 11 on the other end side S2. The support plate portion 11 is a rectangular and plate-like member and supports at least one screw. As illustrated in FIG. 3, a direction perpendicular to a surface of the support plate portion 11 is the first direction D1. The first direction D1 is also a longitudinal direction of the screw.

As illustrated in FIGS. 1 to 3, the magazine 10 supports four screws 20a, 20b, 20c, 20d. Obviously, the number of screws the magazine 10 supports is not limited to four. Any one of the screw(s) the magazine 10 supports may be regarded as “first screw”. Also, any screw that the magazine 10 supports and that contacts the fuel cells 40 in a direction different from the direction the first screw contacts the fuel cells 40 can be regarded as “second screw”.

Each of the screws 20a, 20b, 20c, and 20d is supported so as to be rotatable in a state of penetrating the support plate portion 11 in the first direction D1. As illustrated in FIG. 2, a shaft of each of the screws 20a, 20b, 20c, 20d has an end projecting from the support plate portion 11 on the other end side S2, and pulleys 30a, 30b, 30c, 30d are attached to the respective ends of the screws 20a, 20b, 20c, 20d. Also, a shaft 31 parallel to the first direction D1 is supported onto the support plate portion 11 such that the shaft 31 projects from the support plate portion 11 on the other end side S2 and the shaft 31 is rotatable, and a pulley 30e is attached to the shaft 31. A belt 32 is strapped on the pulleys 30a, 30b, 30c, 30d, and 30e with a predetermined tension applied thereon.

A motor 33 illustrated in FIG. 2 is coupled to the shaft 31, for example, and power generated by the motor 33 rotates the shaft 31 and the pulley 30e. The rotation of the pulley 30e is transferred to the pulleys 30a, 30b, 30c, 30d via the belt 32, and each of the pulleys 30a, 30b, 30c, 30d rotates, resulting in synchronized rotations of the screws 20a, 20b, 20c, 20d. Alternatively, for example, the pulley 30e may not exist, and one of the pulleys 30a, 30b, 30c, 30d may be coupled to the motor 33 and thus rotate, and the pulleys 30a, 30b, 30c, 30d may rotate synchronously via the belt 32.

The pulleys 30a, 30b, 30c, 30d, 30e, the shaft 31, the belt 32, and the motor 33 correspond to an example for a screw driving unit 34 configured to rotate screw(s) including at least the first screw. Nevertheless, the screw driving unit 34 simply needs to be configured to synchronously rotate one or more screws the support plate portion 11 supports, and thus various configurations other than the illustrated one may also be adopted. As such, the configuration including the magazine 10, the one or more screws, and the screw driving unit 34 corresponds to an example for a conveying device 1 configured to align the plurality of fuel cells 40 stacked on each other.

According to FIGS. 1 and 3, the magazine 10 includes a first side plate portion 12, a second side plate portion 13, and a third side plate portion 14. The first side plate portion 12 is a plate member along a first side 11a of the support plate portion 11, and extends from the support plate portion 11 toward the one end side S1 of the first direction D1. Likewise, the second side plate portion 13 is a plate member along a second side 11b of the support plate portion 11, and extends from the support plate portion 11 toward the one end side S1 of the first direction D1. The third side plate portion 14 is a plate member along a third side 11c of the support plate portion 11 and extends from the support plate portion 11 toward the one end side S1 of the first direction D1.

The second side plate portion 13 and the third side plate portion 14 face each other. The second side plate portion 13 and the third side plate portion 14 may be regarded as being parallel to each other. Each of the second side plate portion 13 and the third side plate portion 14 is connected to the first side plate portion 12 along the first direction D1. Each of the second side plate portion 13 and the third side plate portion 14 may be regarded as being connected perpendicularly to the first side plate portion 12. Ends of the first side plate portion 12, the second side plate portion 13, and the third side plate portion 14 on the one end side S1 define an opening 15 of the magazine 10 on the one end side S1. In the magazine 10, in addition to a face on the one end side S1 being the opening 15, a face facing the first side plate portion 12 is also open. The first side plate portion 12, the second side plate portion 13, and the third side plate portion 14 may be a single member in which these plate portions are integrated or may be several separable members.

Each of the first side plate portion 12, the second side plate portion 13, and the third side plate portion 14 supports the screws on the one end side S1. According to FIG. 1, the first side plate portion 12 supports the screws 20a, 20b. The second side plate portion 13 supports the screw 20c. The third side plate portion 14 supports the screw 20d. Specifically, the first side plate portion 12 includes projecting support portions 12a, 12b projecting into the magazine 10 at two positions separate from each other in a direction parallel to the first side 11a of the support plate portion 11 and respectively corresponding to the screws 20a, 20b. The projecting support portion 12a supports the screw 20a such that the screw 20a is rotatable. The projecting support portion 12b supports the screw 20b such that the screw 20b is rotatable.

Similarly, the second side plate portion 13 has a projecting support portion 13c projecting to the inside of the magazine 10 at a position corresponding to the screw 20c in a direction parallel to the second side 11b. The third side plate portion 14 has a projecting support portion 14d projecting to the inside of the magazine 10 at a position corresponding to the screw 20d in a direction parallel to the third side 11c. The projecting support portion 13c supports the screw 20c such that the screw 20c is rotatable. The projecting support portion 14d supports the screw 20d such that the screw 20d is rotatable.

A method of each of the projecting support portions 12a, 12b, 13c, 14d supporting the corresponding screw 20a, 20b, 20c, 20d is not specifically limited. Each of the projecting support portions 12a, 12b, 13c, 14d comprises a hole or notch penetrating therethrough in the first direction D1, and by inserting an end portion (tip) of the screw 20a, 20b, 20c, 20d on the one end side S1 into such hole or notch, each of the projecting support portions 12a, 12b, 13c, 14d rotatably supports the corresponding screw 20a, 20b, 20c, 20d such that the corresponding screw 20a, 20b, 20c, 20d is rotatable. The projecting support portions 12a, 12b, 13c, 14d are shaped not to interfere with the fuel cells 40 being conveyed along the first direction D1.

In the magazine 10, the fuel cells 40 are accommodated such that their edges contact the screw(s). When the magazine 10 is configured to include the screws 20a, 20b, 20c, 20d, as illustrated in FIG. 3, the fuel cells 40 are accommodated in a stacked state in a space surrounded by the screws 20a, 20b, 20c, 20d. Accordingly, in the magazine 10, the screws 20a, 20b, 20c, 20d simply need to be supported such that their longitudinal directions remain parallel to the first direction D1 and the screws 20a, 20b, 20c, 20d are rotatable, and therefore the first side plate portion 12, the second side plate portion 13, and the third side plate portion 14 are not essential. In other words, configurations in which one or more of the first side plate portion 12, the second side plate portion 13, and the third side plate portion 14 do not exist and a configuration in which all the side plate portions 12, 13, and 14 do not exist are all encompassed by the present embodiment.

For example, the magazine 10 may not include the second side plate portion 13 and the third side plate portion 14. Then, instead of the second side plate portion 13 and the third side plate portion 14 in the magazine 10, the end on the one end side S1 of the first side plate portion 12 may be shaped as an open end 16 shown with a two-dot dashed line in FIG. 3. The open end 16 is substantially the same in shape with the opening 15 in FIG. 1 when the open end 16 is viewed from the one end side S1. In other words, the projecting support portions 12a, 12b, 13c, 14d may be arranged in the open end 16 which is a modification of the one end side S1 of the first side plate portion 12, and the screws 20a, 20b, 20c, 20d may be rotatably supported by the open end 16 on the one end side S1.

The screws 20a, 20b, 20c, 20d are categorized into so-called external screws. The screws 20a, 20b, 20c, 20d extend along the first direction D1, and each have an outer peripheral surface with a helical thread groove in a portion on the one end side S1 relative to the support plate portion 11. In a cross-sectional view, since each thread groove is sandwiched between thread ridges, the thread groove and the thread ridge appear alternately in the helical pattern on the outer peripheral surface, it is also possible to say that a helical thread ridge is defined on the outer peripheral surface of each of the screws 20a, 20b, 20c, 20d.

Signs D2, D3, D4 each indicate a direction in which the respective screw contacts the fuel cells 40. The directions D2, D3, D4 are all perpendicular to the first direction D1 and are different from each other. The direction D2 is perpendicular to the directions D3 and D4. The direction D3 and the direction D4 are opposite each other. As an example, when one of the screws 20a, 20b is called the first screw, the first screw may be regarded as its outer peripheral surface contacting the plurality of fuel cells 40 in the direction D2 (second direction) when the plurality of fuel cells 40 is accommodated in the magazine 10. As another example, when the screw 20c is called a second screw, the second screw may be regarded as its outer peripheral surface contacting the plurality of fuel cells 40 in the direction D3 (third direction) when the plurality of fuel cells 40 is accommodated in the magazine 10. As yet another example, when the screw 20d is called a third screw, the third screw may be regarded as its outer peripheral surface contacting the plurality of fuel cells 40 in the direction D4 (fourth direction) when the plurality of fuel cells 40 is accommodated in the magazine 10.

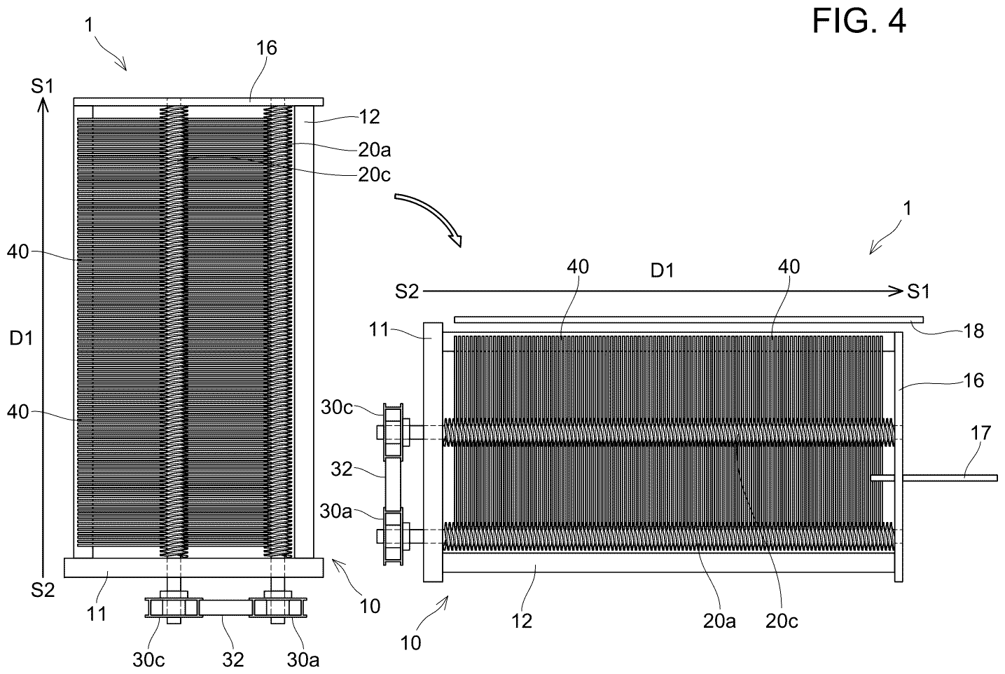

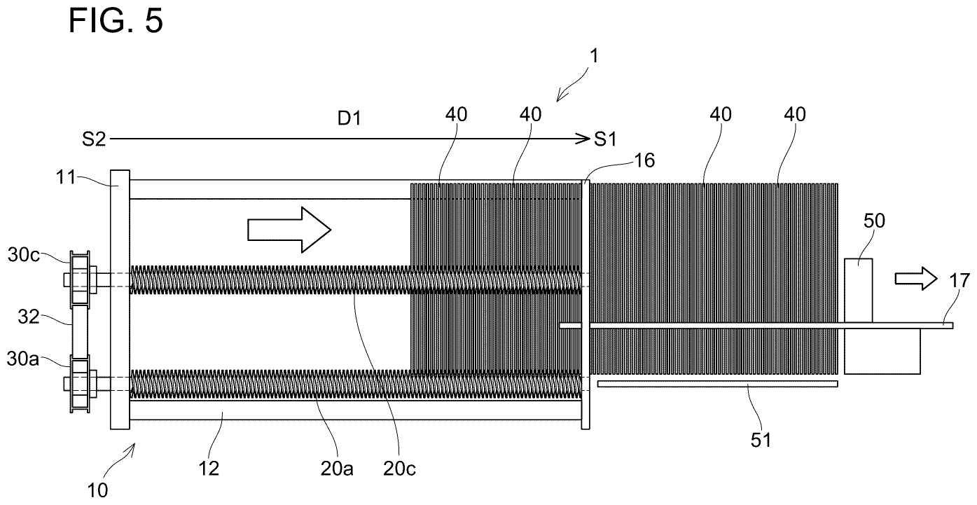

Next, with reference to FIGS. 4, 5, and 6, a conveying method performed by the conveying device 1 will be described. FIG. 4 illustrates how a posture of the conveying device 1 changes as seen along the above-mentioned direction D3. FIG. 5 illustrates how the conveying device 1 conveys the fuel cells 40 in the same viewpoint as that of FIG. 4. In FIGS. 4 and 5, for better viewability, the example in which the magazine 10 does not include the second side plate portion 13 and the third side plate portion 14 and the first side plate portion 12 has the open end 16 is shown. In the following description, the open end 16 may be replaced with the opening 15.

As illustrated in a left side of FIG. 4, the plurality of fuel cells 40 in the stacked state is accommodated in the magazine 10 held in a posture (first posture) in which the support plate portion 11 is located at a bottom and the first direction D1 is oriented upward (accommodating process). In the present embodiment, the accommodating process does not require precision in alignment of the fuel cells 40. This is because the plurality of fuel cells 40 will be properly aligned in a conveying process to be described later. The alignment of the fuel cells 40 means that the fuel cells 40 are arranged with minimal misalignment possible between one another in a direction parallel to surfaces of the fuel cells 40, i.e., in a direction perpendicular to the first direction D1. Smaller misalignment means that the alignment is more precise. Since the work of stacking the fuel cells 40 and accommodating the same in the magazine 10 does not require precision in alignment, such work can be facilitated and accelerated.

Next, the magazine 10 with the plurality of fuel cells 40 accommodated therein in the first posture is rotated approximately 90 degrees, and as illustrated in a right side of FIG. 4, the magazine 10 is held in a posture (second posture) in which the first side plate portion 12 is located at the bottom and the first direction D1 is oriented along a horizontal direction or a substantially horizontal direction. Here, considering the ease of accommodating the fuel cells 40 in the magazine 10, the fuel cells 40 were described as accommodated in the magazine 10 in the first posture as mentioned above. In the accommodating process, however, it is possible to stack the fuel cells 40 along the first direction D1 and accommodating them in the magazine 10 in the second posture. As such, the process of rotating the magazine 10 as illustrated in FIG. 4 is not essential in the present embodiment. Accompanying such accommodating process, a contact process of having the outer peripheral surface of the first screw contact the plurality of fuel cells 40 accommodated in the magazine 10 in the second direction perpendicular to the first direction D1 is also executed.

Next, the screw driving unit 34 causes the screws to rotate. As such, the screws 20a, 20b, 20c, 20d including the first screw rotate synchronously, for example, while maintaining their postures in the first direction D1, and the plurality of fuel cells 40 engages with the respective thread grooves of the screws 20a, 20b, 20c, 20d, and the plurality of fuel cells 40 is conveyed in the aligned state as illustrated in FIG. 5 toward the one end side S1 (conveying process). Alternatively, one screw driving unit may be disposed corresponding to each of the screws 20a, 20b, 20c, 20d including the first screw, and the screw driving units may be configured to rotate their corresponding screws independent of one another.

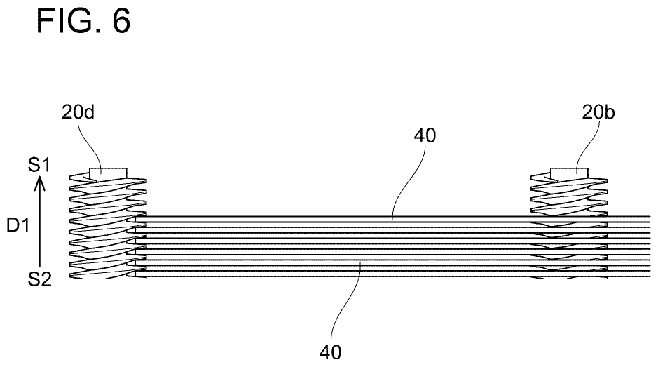

FIG. 6 illustrates a state where the screws and the fuel cells 40 engage with each other in an enlarged view. FIG. 6 shows how the plurality of fuel cells 40 engages with the thread grooves of the screw 20b and the screw 20d from a perspective opposed to the direction D2. For example, the screws which the magazine 10 comprises all have a same shape, and also are located at the same positions along the first direction D1. The shape of the screws includes, for example, an outer diameter of the thread ridge, a pitch of the thread ridge, which is a distance between adjacent thread ridges in the first direction D1, a depth of the thread groove, and an angle of a slope of the thread groove. The pitch of each screw is set to a value greater than a thickness of each fuel cell 40 such that edges of the fuel cells 40 fit into the thread groove. When this screw rotates, the fuel cell(s) 40 whose edge(s) had not been fitted into the thread groove also come to have their edge(s) fitted into the thread groove, resulting in the respective fuel cells 40 being aligned. The respective screws of the magazine 10 may include screw(s) with different shape(s). For example, one screw may be a right-hand screw, while another screw may be a left-hand screw.

In the conveying process, the fuel cells 40 which were conveyed toward the one end side S1 along the first direction D1 accompanying the rotations of the screws and have reached the open end 16, are pushed from behind by another stack of fuel cells 40 moving toward the one end side S1, and exit from the magazine 10 from the open end 16 and further proceed toward the one end side S1. A stopper 50 for supporting the fuel cell 40 situated farthest on the one end side S1 is disposed at a predetermined position on the one end side S1 relative to the open end 16. Also, a platform 51 is disposed between the open end 16 and the stopper 50, in which the platform 51 is configured to support respective lower ends of the fuel cells 40 moving along the first direction D1 on a line connecting the screws 20a, 20b and the stopper 50. The stopper 50 is configured to move toward the one end side S1 by a certain distance by being pushed by the fuel cells 40.

When the fuel cell 40 situated farthest on the other end side S2 has reached the open end 16 along with the rotations of screws, the conveying process by the conveying device 1 can be regarded as being completed. The plurality of fuel cells 40 aligned on the platform 51 between the open end 16 and the stopper 50 is thereafter subjected to unillustrated various processes including a process of being accommodated in an unillustrated stack case.

As illustrated in FIGS. 1, 4, and 5, the conveying device 1 may comprise one or more guide bars 17. The guide bar(s) 17 are bar(s) extending in the first direction D1. The guide bar(s) 17 are attached to one or more of the first side plate portion 12, the second side plate portion 13, the third side plate portion 14, and the open end 16, for example. Alternatively, the guide bar(s) 17 may be separate member(s) from the magazine 10 and held horizontally at predetermined position(s), and when the magazine 10 is in the second posture, the first direction D1 of the magazine 10 and the guide bar(s) 17 may become parallel.

As illustrated in FIGS. 1 and 3, the fuel cells 40 comprise notches 41. The notches 41 penetrate the fuel cells 40 in a thickness direction and also are open on the edges of the fuel cells 40. The notches 41 are defined at same positions in each of the plurality of fuel cells 40. In the conveying process, when the plurality of fuel cells 40 is conveyed toward the one end side S1 by the rotations of the screws, the guide bars 17 are sequentially inserted into the notches 41 defined in each of the plurality of fuel cells 40. Due to this, precision in alignment of the plurality of fuel cells 40 can further be enhanced. Here, holes penetrating the fuel cells 40 in the thickness direction may be defined instead of the notches 41 at the same positions, and the guide bars 17 may be inserted into these holes.

The present embodiment may further include, after the accommodating process, a pressing process of bringing the edges of the plurality of fuel cells 40 that do not contact any screws into contact with a pressing member 18. According to the example shown in FIG. 4, the edges of the fuel cells 40 that do not contact any screws are a part of the edges opposite from a part of the edges that contacts the screws 20a, 20b, i.e., a part of the edges oriented upward. The pressing member 18 may be a plate parallel to the first side plate portion 12 or may be a pole parallel to the first direction D1. The pressing process enables the respective fuel cells 40 to surely contact the screws and can suppress misalignment between the fuel cells 40, and accordingly precision in alignment can be enhanced. The pressing process can be regarded as a part of the contact process.

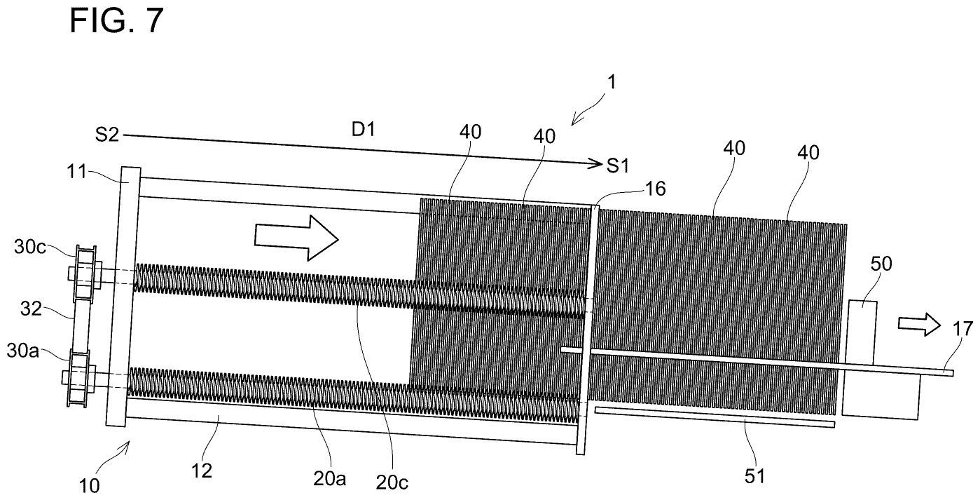

The magazine 10 may be held in a posture in which one end is lowered such that the first direction D1 is inclined relative to the horizontal direction as the second posture. FIG. 7 illustrates how the conveying device 1 in the inclined posture conveys the fuel cells 40. As to FIG. 7, different points from FIG. 5 will only be described. According to FIG. 7, the first direction D1 of the magazine 10 is lowered on the one end side S1 than the other end side S2, and thus is inclined relative to the horizontal direction. When the first direction D1 of the magazine 10 is inclined, the platform 51 and the stopper 50 are also inclined similarly, and thus they receive the fuel cells 40 being ejected from the open end 16 further on the one end side S1 than the open end 16. By making the first direction D1 inclined, the fuel cells 40 can be conveyed more smoothly toward the one end side S1.

According to the present embodiment, the conveying device 1 is configured to align the plurality of fuel cells 40 stacked on each other. The conveying device 1 comprises: the magazine 10 accommodating the plurality of fuel cells 40 in the stacked state along the first direction D1 and having one end in the first direction D1 being open; the first screw (e.g., screw 20a) extending along the first direction D1 and having the outer peripheral surface with the helical thread groove; and the screw driving unit 34 configured to rotate the first screw. The outer peripheral surface of the first screw contacts the plurality of fuel cells 40 in the second direction perpendicular to the first direction D1 when the plurality of fuel cells 40 is accommodated in the magazine 10.

According to the aforementioned configuration, the plurality of fuel cells 40 accommodated in the magazine 10 in the stacked state falls into a state where each fuel cell 40 is aligned by naturally fitting into the thread groove of the first screw by the screw driving unit 34 rotating the first screw, and is conveyed toward the one end along the first direction D1. By adjusting a rotation speed of the first screw at which the screw driving unit 34 rotates the first screw, a speed of the conveying can also be easily adjusted. Due to this, as compared to conventional methods, the plurality of fuel cells 40 can be conveyed and stacked in an aligned state with high precision and also at a high speed. This allows for improvement in quality of a fuel cell stack and acceleration in production of the fuel cell stack.

In the conventional pick-and-place method, there was a concern that the fuel cells 40 might be contaminated by a foreign matter entering between the fuel cells 40 because of wear occurring on a suction pad, for example, when the suction pad is used. In the present embodiment, since a suction pad is not used, such contamination with a foreign matter can be avoided.

Also, according to the present embodiment, the conveying device 1 may further comprise the guide bar(s) 17 extending along the first direction D1, inserted into the notch(es) 41 or hole(s) defined in each of the plurality of fuel cells 40 when the plurality of fuel cells 40 is conveyed toward the one end by rotation of the first screw. According to the above configuration, precision in alignment of the fuel cells 40 can further be enhanced because the guide bar(s) 17 are inserted into the notches 41 or holes defined in each of the fuel cells 40 as the plurality of fuel cells 40 is conveyed.

According to the present embodiment, the conveying device 1 may further comprises a screw besides the first screw. That is, the conveying device 1 further comprises the second screw (e.g., the screw 20c) extending along the first direction D1 and having the outer peripheral surface with the helical thread groove, wherein the outer peripheral surface of the second screw contacts the plurality of fuel cells 40 in the third direction perpendicular to the first direction D1 and different from the second direction when the plurality of fuel cells 40 is accommodated in the magazine 10. The screw driving unit 34 rotates the first screw and the second screw synchronously. According to the above configuration, since the screws are made to contact the plurality of fuel cells 40 accommodated in the magazine 10 in a plurality of different directions and the plurality of fuel cells 40 is conveyed by the synchronized rotations of the respective screws, respective positions of the fuel cells 40 can be stabilized while being conveyed.

Also, according to the present embodiment, the magazine 10 may be configured to maintain the posture of the magazine 10 such that the first direction D1 is oriented along the horizontal direction or such that the first direction D1 is inclined with respect to the horizontal direction with the one end lowered. According to the above configuration, by making the first direction D1 horizontal, the plurality of fuel cells 40 can be stacked in the horizontal direction, not in an up-down direction (i.e., vertically). By stacking the plurality of fuel cells 40 in the horizontal direction, one of the fuel cells 40 does not have to bear weights of the other fuel cells 40, such that the individual positions of the fuel cells 40 can be easily modified. Further, by making the first direction D1 inclined with respect to the horizontal direction, the plurality of fuel cells 40 can be smoothly conveyed.

As can be known from the aforementioned description, the present embodiment discloses also a conveying method for aligning the plurality of fuel cells 40 stacked on each other. The conveying method comprises: accommodating the plurality of fuel cells 40 in the stacked state along the first direction D1 in the magazine 10 having one end in the first direction D1 being open; having the outer peripheral surface of the first screw, the first screw extending along the first direction D1 and the outer peripheral surface having the helical thread groove, contact the plurality of fuel cells 40 accommodated in the magazine 10 in the second direction perpendicular to the first direction D1; and conveying the plurality of fuel cells 40 engaged in the thread groove toward the one end by rotation of the first screw. The effects described in the present embodiment can also be brought forth by such conveying method.

According to the conveying device 1, it is also possible to conduct conveying in a reverse direction from the one described above. That is, the screw driving unit 34 can convey the fuel cells 40 from the one end side S1 to the other end side S2 by rotating in a reverse direction (counterrotating) from the rotation direction of the screws when conveying the fuel cells 40 from the other end side S2 to the one end side S1. Specifically, the conveying device 1 conveys sequentially the plurality of fuel cells 40, supplied from outside the open end 16 toward the open end 16, from the one end side S1 toward the other end side S2, and accommodates them in the stacked state in the magazine 10.

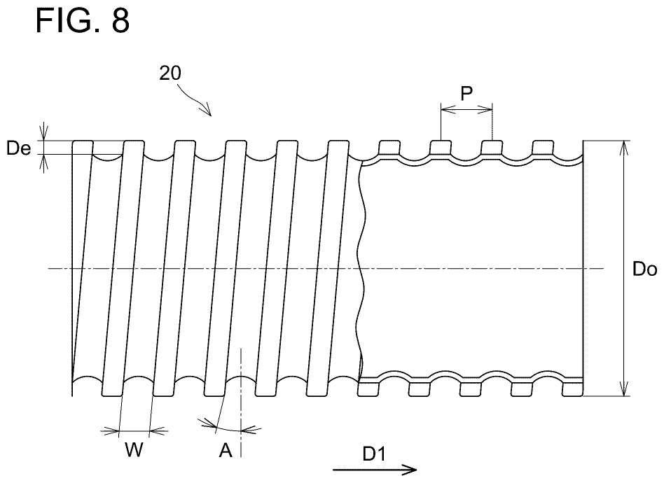

The shape of the screws will be described in detail. FIG. 8 shows a part of a screw 20. The screw 20 is the first screw. Features of the screw 20 described below also apply to the second screw. The screw 20 can be regarded as each of the screws 20a, 20b, 20c, and 20d. The screw 20 has an outer diameter Do of the thread ridge, for example, of 20 mm to 40 mm. For example, the screw 20 has a pitch P of the thread ridge, which is a distance between adjacent thread ridges in the first direction D1, of 3 to 15 times the thickness of each fuel cell 40, that is, the thickness of a single fuel cell 40. For example, the screw 20 has a depth De of the thread groove of 1.5 mm to 5 mm. For example, the screw 20 has an inclination A of the thread ridge of 10 to 30 degrees. The inclination A may be considered as an angle of a slope of the thread groove. The inclination A is the inclination of the thread ridge with respect to a direction that is orthogonal to the first direction D1. The screw 20, for example, has a width W of the thread groove in the first direction D1 of 0.5 to 10 times the thickness of each fuel cell 40. The thickness of each fuel cell 40, for example, is 0.05 mm to 1.2 mm. Preferably, the thickness of each fuel cell 40 is 0.4 mm to 0.6 mm.

Preferably, the screw 20 has the pitch P of 9 to 15 times the thickness of each fuel cell 40. Preferably, the screw 20 has the width W of 3 to 5 times the thickness of each fuel cell 40.

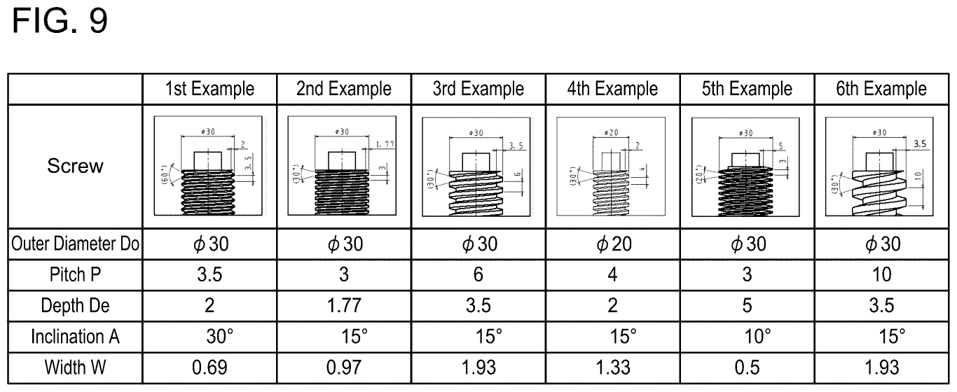

FIG. 9 shows first to sixth examples as a plurality of examples of screws 20. According to FIG. 9, the screw 20 in the first example has: the outer diameter Do=30 mm, the pitch P=3.5 mm, the depth De=2 mm, the inclination A=30°, and the width W=0.69 mm. Similarly, features of the screws 20 in the second to sixth examples are as shown in FIG. 9.

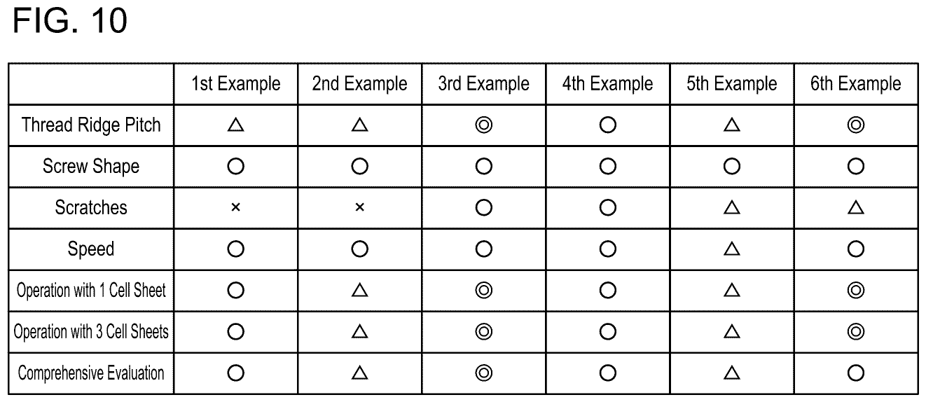

FIG. 10 shows test results of multiple test items when the fuel cell(s) 40 were conveyed with the screws 20 incorporated into the magazine 10. In other words, FIG. 10 shows test results of: when the screw 20 in the first example was used as each of the screws 20a, 20b, 20c, and 20d; when the screw 20 in the second example was used as each of the screws 20a, 20b, 20c, and 20d; when the screw 20 in the third example was used as each of the screws 20a, 20b, 20c, and 20d; when the screw 20 in the fourth example was used as each of the screws 20a, 20b, 20c, and 20d; when the screw 20 in the fifth example was used as each of the screws 20a, 20b, 20c, and 20d; and when the screw 20 in the sixth example was used as each of the screws 20a, 20b, 20c, and 20d.

Test results for a test item “Thread Ridge Pitch” show results of testing whether a clearance was properly secured so that adjacent fuel cells 40 in the first direction D1 would not contact each other during conveying. Test results (a double circle, a single circle, a triangle, a cross (X) mark, shown in FIG. 10) are as follows: a double circle is a highest evaluation, and a cross (X) mark is a lowest evaluation. In other words, an order of evaluation is a double circle>a single circle>a triangle>a cross (X) mark. Test results for a test item “Screw Shape” show results of testing whether a shape of a bottom of the thread groove is appropriate with minimal contact with the fuel cell(s) 40. As to the test item “Screw Shape”, all of the examples were “a single circle” with no difference between the examples because the shapes of the bottoms of the thread grooves in all the examples were flat.

Test results for a test item “Scratches” show results of testing whether an amount of wear and/or scratches at a contact part of the fuel cells 40 with the screws 20 is small. Test results for a test item “Speed” show results of testing whether the fuel cells 40 were conveyed stably (with little vibration or wobbling) when a rotation speed (number of rotations per minute) of the screws 20 was set to 500 rpm. Test results for a test item “Operation with 1 Cell Sheet” show results of testing whether one sheet of fuel cell 40 was conveyed stably when the rotation speed of the screws 20 was set to 300 rpm. Test results for a test item “Operation with 3 Cell Sheets” show results of testing whether three adjacent sheets of fuel cells 40 in the first direction D1 were conveyed stably when the rotation speed of the screws 20 was set to 300 rpm.

According to FIG. 10, the test results of when the screw 20 in the third example was used are all “a single circle” or “a double circle”, thus the third example had a highest comprehensive evaluation among all the examples shown in FIG. 9. According to the features of the screws 20 including these examples, a conveying device with screw(s) and a conveying method with screw(s) that can appropriately secure the clearance between adjacent fuel cells 40, that have the shape of the bottom of the thread groove that is favorable in terms of contact with the fuel cells 40, that can suppress scratches and/or wear on the fuel cells 40, and that can stably convey one or more sheets of fuel cells 40 at a rotation speed of 300 rpm or more, are provided.

In the first screw, at least one of the outer diameter Do, the pitch P, the depth De, the inclination A, and the width W may not be constant in the first direction D1. In other words, in the screw 20, at least one of the outer diameter Do, the pitch P, the depth De, the inclination A, and the width W may vary at different positions in the first direction D1. More specifically, a single screw 20 may have a shape that is made by combining two or more of the above examples.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. A conveying device configured to align a plurality of fuel cells stacked on each other, the conveying device comprising:
a magazine accommodating the plurality of fuel cells in the stacked state along a first direction and having one end in the first direction being open;
a first screw extending along the first direction and having an outer peripheral surface with a helical thread groove, wherein the outer peripheral surface of the first screw contacts the plurality of fuel cells in a second direction perpendicular to the first direction when the plurality of fuel cells is accommodated in the magazine; and
a screw driving unit configured to rotate the first screw.

2. The conveying device according to claim 1, further comprising a guide bar extending along the first direction, inserted into a notch or a hole defined in each of the plurality of fuel cells when the plurality of fuel cells is conveyed toward the one end by rotation of the first screw.

3. The conveying device according to claim 1, further comprising a second screw extending along the first direction and having an outer peripheral surface with a helical thread groove, wherein the outer peripheral surface of the second screw contacts the plurality of fuel cells in a third direction perpendicular to the first direction and different from the second direction when the plurality of fuel cells is accommodated in the magazine,
wherein the screw driving unit rotates the first screw and the second screw synchronously.

4. The conveying device according to claim 1, wherein the magazine is configured to maintain a posture of the magazine such that the first direction is oriented along a horizontal direction or such that the first direction is inclined with respect to the horizontal direction with the one end lowered.

5. The conveying device according to claim 1, wherein the first screw has an outer diameter of a thread ridge of 20 to 40 mm, a pitch of the thread ridge, which is a distance between adjacent thread ridges in the first direction, of 3 to 15 times a thickness of each of the fuel cells, a depth of the thread groove of 1.5 to 5 mm, an inclination of the thread ridge of 10 to 30 degrees, and a width of the thread groove in the first direction of 0.5 to 10 times the thickness of each fuel cell.

6. The conveying device according to claim 5, wherein the first screw has the pitch of 9 to 15 times the thickness of each fuel cell.

7. The conveying device according to claim 5, wherein the first screw has the width of the thread groove of 3 to 5 times the thickness of each fuel cell.

8. The conveying device according to claim 5, wherein in the first screw, at least one of the outer diameter of the thread ridge, the pitch, the depth of the thread groove, the inclination of the thread ridge, and the width of the thread groove, is not constant in the first direction.

9. A conveying method for aligning a plurality of fuel cells stacked on each other, the conveying method comprising:
accommodating the plurality of fuel cells in the stacked state along a first direction in a magazine having one end in the first direction being open;
having an outer peripheral surface of a first screw, the first screw extending along the first direction and the outer peripheral surface having a helical thread groove, contact the plurality of fuel cells accommodated in the magazine in a second direction perpendicular to the first direction; and
conveying the plurality of fuel cells engaged in the thread groove toward the one end by rotation of the first screw.
